(19) United States
(12) Patent Application Publication
(10) Pub. No.: US 2008/0099967 A1
(43) Pub. Date: May 1, 2008

(54) Vehicle Level Detection

(75) Inventors: Joachim Spratte, Osnabruck (DE); Metin Ersoy, Walluf (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSCHAFEN AG, Friedrichschafen (DE)

(21) Appl. No.: 11/575,424

(22) PCT Filed: Sep. 14, 2005
(86) PCT No.: PCT/DE05/01606

§ 371 Date: Mar. 16, 2007

(30) Foreign Application Priority Data
Sep. 17, 2004 (DE) 10 2004 045 670.4

(51) Int. Cl. F16F 9/53; G01D 5/12; G01B 7/00

(52) U.S. Cl. 267/140.14; 324/207.24; 324/207.2

(57) ABSTRACT

A device for measuring the spring compression position of a motor vehicle, with a number of axle components (3) and a chassis (2) includes spring elements (1) arranged between the axle components (3) and the chassis (2), as well as with at least one magnet array (7) and at least one magnetic field sensor (8). The magnetic field sensor (8) is displaced in relation to the magnet array (7) in the case of a change in the spring compression position of the motor vehicle. The magnet array (7) or the magnetic field sensor (8) is arranged at a point of the spring element (1) that moves in case of a change in the spring compression position in relation to both the chassis (2) and in relation to the axle component (3).

### CROSS REFERENCE TO RELATED APPLICATIONS

This application is a United States National Phase application of International Application PCT/DE2005/001606 and claims the benefit of priority under 35 U.S.C. § 119 of German Patent Application DE 10 2004 045 670.4 filed Sep. 17, 2004, the entire contents of which are incorporated herein by reference.

### FIELD OF THE INVENTION

The present invention pertains to a device for measuring the spring compression position of a motor vehicle, with a number of axle components and a chassis, wherein the spring elements are arranged between the axle components and the chassis and pertains to a motor vehicle with a device for measuring the spring compression.

### BACKGROUND OF THE INVENTION

With the aim of achieving a constant vehicle level even in different loaded states, for example, sensors are used for height regulation and the sensors determine the state of spring compression by determining the angle of rotation. These sensors are fastened in the area of the wheel suspension mostly in the area of the wheel housing on the chassis of the motor vehicle and are connected to a control arm by means of a steering knuckle, so that a change in the state of spring compression due to loading causes the control arm to move closer to the chassis and thus brings about a corresponding pivoting of the angle of rotation sensor fastened to the control arm. The angle of rotation sensor emits the change in the angle of the steering knuckle as an electrical variable to obtain a control signal, by which level control of the vehicle takes place by means of a corresponding signal processing. The drawback of this type of level control is the complicated design of this sensor as well as the large space needed for its installation. Due to the exposed arrangement of this sensor in the wheel housing of the vehicle, the sensor is highly susceptible to damage. e.g., due to stone chips. Another drawback is the wear caused by mechanical motion and the inaccuracy of the signal, which increases therewith.

DE 4413341 C2 discloses a sensor array that is subject to reduced wear due to a contactless measuring means by means of magnetic field sensors. Two permanent magnets directed in the same direction relative to one another are arranged in the exemplary embodiment on two different components, on the control arm, on the one hand, and on the chassis, on the other hand. The change in the spring compression position, for example, due to loading of the vehicle, is detected by means of an asymmetrically arranged magnetic field sensor fixed between the permanent magnets by the sensor converting a change in the intensity of the magnetic field, which change is brought about by the change in the height and the change in the relative distance between the two permanent magnets, which latter change is associated therewith, into an electrical variable for obtaining a control signal. The drawback is, on the one hand, the complicated design and the large number of sensor array assembly units needed, and, on the other hand, the large space needed for installation because of the manner of arrangement.

### SUMMARY OF THE INVENTION

Therefore, the object of the present invention is to provide a device that makes possible the reliable measurement of the spring compression position while requiring little space.

The device for measuring the spring compression position of a motor vehicle, with a number of axle parts and a chassis, is provided in which spring elements are arranged between the axle components and the chassis. The device is mounted such that either a magnet array or a magnetic field sensor is arranged directly at a point of the spring element that moves in relation to both the chassis and the axle component in case of a change in the spring compression position. The magnet array and the magnetic field sensor form the only two assembly units of the device according to the present invention. The assembly unit of the device that is not arranged on the spring element is thus fastened to the chassis or to the control arm in such a way that it makes the determination with the other assembly unit in the smallest possible space by a simple detection of the spring compression position on the basis of the force generated during the loading, which force acts directly on the spring element, and a change in the distance between the individual members of the spring. This change in distance can be determined, for example, by means of Hall IC sensors and transmitted as an electrical variable for further processing into a control signal.

It is advantageous if the magnet array has two like magnetic poles facing each other relative to an air gap, wherein the magnetic field intensity becomes zero in one area of the air gap. The use of the zero field detection proved to be advantageous because the zero field can be detected especially by means of Hall ICs with very high precision and with little susceptibility to interference variables from the immediate environment.

Precisely the use of a linear Hall IC proved to be especially advantageous in the zero field detection for contactless measurement, because this can show even very small changes in the intensity of the magnetic field. As a result, only a very small deflection is necessary, which means that compact design and small dimensions of the assembly unit are possible.

If the magnetic field sensor is advantageously arranged such that it detects the area of the air gap in which the field intensity is zero in the normal position of the motor vehicle, the device can be used especially well for the level control of the motor vehicle. The sensor may be advantageously simply coupled for this purpose with the adjusting actuators of the level control mechanism via a control.

Depending on the arrangement of the magnetic field sensor, the sensor may also be used as an overload sensor, for example, in trucks, by the zero field being arranged in the area of the maximum allowable axle load. If a value that can be set and also varied depending on the needs is externally exceeded, an electric signal can be generated by the sensor. This could be an audio warning signal or, e.g., a signal to a vehicle immobilizer. It is also conceivable to use the device to level the headlights, for example, by changing the angle to which the headlights are set.

To keep the space needed for installation as small as possible, it is, furthermore, advantageous to provide the magnetic field sensor on the chassis and the magnet array directly on the spring element.

Another advantageous embodiment of the device according to the present invention provides for a multipart spring element, wherein the spring element is formed by a first spring with a soft characteristic, for example, a coil spring, as well as by at least one second spring with a hard characteristic, for example, a plate spring, and the individual springs are arranged one after the other in the direction of the spring and are in contact with one another in a mounting point, the magnet array or the magnetic field sensor being fastened to the mounting point. The spring excursion of the actual spring compression process of the spring element of the motor vehicle is advantageously reduced by the plate springs. The magnet array and the magnetic field sensors are thus exposed to short spring excursions only, which is tantamount to faster signal processing.

An exemplary embodiment of the device according to the present invention will be explained in more detail below on the basis of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the arrangement of the device in case of a one-part spring element;

FIG. 2 is a schematic view of the arrangement of the device in case of a multipart spring element; and

FIG. 3 is an enlarged sectional view of a schematic view of the multipart spring strut with magnetic poles and magnetic field sensors.

### DESCRIPTION OF THE PREFERRED EMBODIMENTS

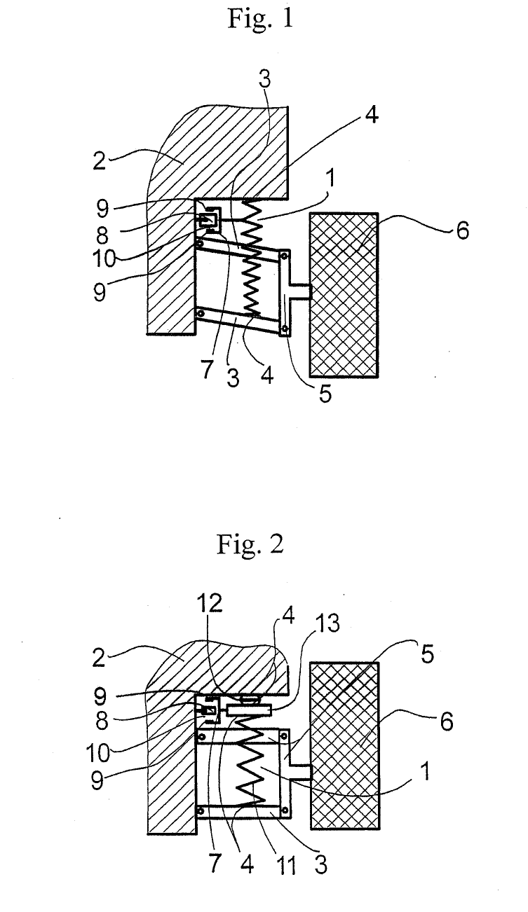

Referring to the drawings in particular, FIG. 1 shows a schematic view of the arrangement of the device in the case of a one-part spring element 1. A chassis 2 of the motor vehicle and one of the axle components 3 form here support surfaces 4 of the spring element 1, which is inserted with a prestress between the chassis 2 and the axle components 3. The axle components 3 are connected to a wheel 6 via a steering knuckle 5. A magnet array 7 is fastened directly to the spring element 1 in the upper area of the spring element 1, which is designed as a coil spring in the exemplary embodiment. Opposite hereto, a magnetic field sensor 8 is fastened to the chassis 2 such that the magnetic field sensor 8 is located in the area between two magnetic poles 9 of the magnet array 7, which, facing each other, form an air gap 10. The magnetic poles 9 are arranged facing each other as like poles, so that the magnetic field intensity becomes zero in one place in the air gap 10 formed by the magnetic poles. If the magnetic field sensor 8 is located in the area of this plane, for example, when the motor vehicle is in the normal position, no field intensity is detected by the magnetic field sensor 8. The magnetic field sensor 8 in the form of a linear Hall IC is able to detect an increase in the intensity of the field (field intensity) in case of the slightest shift from this normal position.

FIG. 2 shows a schematic view of the arrangement of the device, in which the spring element 1 has a multipart design. The spring element is composed in this exemplary embodiment of a coil spring 11 and a plurality of plate springs 12 as well as a mounting point 13 arranged between the coil spring 11 and the plate spring 12. The coil spring 11 and the plate springs 12 are connected in series with one another. The axle component 3 of the motor vehicle, which is in turn connected to the wheel 6 via the steering knuckle 5, and the mounting point 13 form the support surfaces 4 for the coil spring 11, and the mounting point 13 as well as the chassis 2 form the support surfaces 4 for the plate springs 12. The magnet array 7 is fastened at the mounting point 13, as a result of which the mounting of the magnetic field sensor 8 is simplified, on the one hand, and, on the other hand, the risk that the magnet array 7 is shifted from the position of the magnet array 7 and the magnetic field sensor 8 relative to one another, which position is optimal for the detection, in case of a possible twisting due to compression of the coil spring 11 forming the one-part spring element (see FIG. 1), is minimized. The magnetic field sensor 8 is arranged in the air gap 9 of the magnet array 7. On the other side, it is fastened to the chassis 2 of the motor vehicle.

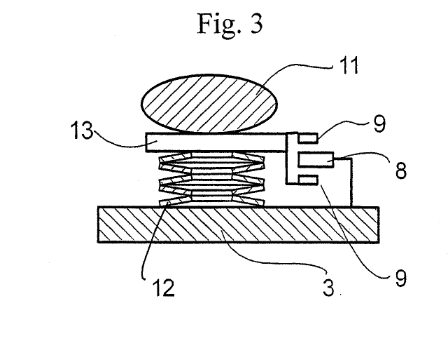

FIG. 3 shows an enlarged sectional view of the schematic view of the multipart spring strut with the magnetic poles 9 and the magnetic field sensor 8. A lowermost turn of the coil spring 11 lies on the mounting point 13 in this case as well. For example, the magnetic poles 9 are fastened to the mounting point 13. The magnetic field sensor 8 arranged between the magnetic poles 9 is connected to the axle component 3 on its side facing away from the magnetic poles 9. It is also conceivable to arrange the magnetic field sensor 8 at the mounting point 13 while the magnetic poles 9 are fastened at the same time to the axle component 3. Five plate springs 12 are connected in series with the coil spring 11 via the mounting point 13 under the mounting point 13, the plate springs 12 being arranged such that the smallest and largest diameters of the individual plate springs 12 touch each other.

The magnetic field sensor 8 is arranged in the exemplary embodiment according to FIG. 1 such that in the normal position of the motor vehicle, it is in the plane of the air gap 10, in which the intensity of the field (field intensity) equals zero. The magnetic field sensor 8 detects no magnetic field in this position. If the vehicle is, for example, loaded, the spring element 1 is compressed more. The magnet array 7 moves as a result upward relative to the chassis 2 simultaneously with the spring element 1. Since the magnetic field sensor 8 is fastened to the chassis 2 of the motor vehicle, the position of the magnetic field sensor does not change in space. By contrast, the smallest change in the position of the magnet array 7 shifts the position of the two magnetic poles 9, as a result of which an increase in the intensity of the magnetic field is immediately detected by the magnetic field sensor 8. If the vehicle is again unloaded, the spring element 1 expands and the magnet array 7 moves downward together with the spring element 1 relative to the magnetic field sensor 8, which in turn brings about a shift of the magnetic poles 9 and thus a reduction of the intensity of the magnetic field in the air gap 10.

It is also conceivable to arrange the magnetic field sensor 8 on the spring element 1 while the magnet array 7 is fastened at the same time to the chassis 2 of the motor vehicle. A change in the load relative to the vehicle would then bring about a change in the position of the magnetic field sensor 8 within the air gap 10 formed by the magnetic poles 9 of the magnet array 7, as a result of which a change in the intensity of the magnetic field could likewise be detected by the magnetic field sensor 8.

The coil springs 11 and the plate springs 12 are also compressed greatly corresponding to their characteristics in the case of the multipart spring element 1 according to FIG. 2. A spring excursion performed by the coil spring 11 now represents a main spring excursion Δs₁, and a spring excursion of the plate springs 12 represents a spring excursion Δs₂. Since the characteristics of the plate springs 12 are substantially harder than those of the coil spring 11, the spring excursion deltas₁ performed by the coil spring 11 is substantially greater than the spring excursion deltas₂ of the plate springs 12. The spring excursion of the actual spring compression process of the spring element of the motor vehicle is thus shown in a transmission ratio that can be selected by selecting the spring rate and the number of the plate springs 12. The magnet array 7 and the magnetic field sensor 8 are thus exposed to the smaller spring excursion Δs₂ only, which is equivalent to a smaller installation space.

Due to the magnetic field sensor being fastened to the axle component 3 according to FIG. 3, the change in the intensity of the magnetic field is caused by the fact that the coil spring is loaded more heavily and applies a stronger force on the mounting part 13, for example, during the loading of the vehicle, as a result of which the plate springs 12 located under the mounting part 13 are likewise compressed and the relative distance between the axle component 3 and the mounting point 13 decreases corresponding to the particular characteristics of the plate springs 12. This in turn brings about a change in the position of the magnetic field sensor 8 between the magnetic poles 9, and a change in the intensity of the magnetic field can thus be detected by the magnetic field sensor 8. If the vehicle is unloaded, the relative distance between the mounting point 13 and the axle component 3 increases correspondingly. The spring excursion of the spring compression process proper of the spring element of the motor vehicle can thus be represented by the plate springs 12 in a transmission ratio that can be set by selecting the spring rate and the number of plate springs 12 in this exemplary embodiment as well.

While specific embodiments of the invention have been shown and described in detail to illustrate the application of the principles of the invention, it will be understood that the invention may be embodied otherwise without departing from such principles.

1. A device for measuring the spring compression position of a motor vehicle, the device comprising:
a number of axle components;
a chassis;
spring elements arranged between said axle components and said chassis;
a magnet array;
a magnetic field sensor displaced in relation to said magnet array in case of a change in the spring compression position of the motor vehicle said magnet array or said magnetic field sensor being arranged at a point of said spring element that moves during a change in the spring compression position both in relation to said chassis and in relation to said axle component.

2. A device in accordance with claim 1, wherein said magnet array has two like magnetic poles facing each other relative to an air gap, wherein the magnetic field intensity becomes zero in one area of said air gap.

3. A device in accordance with claim 1 wherein said spring element is a multipart element and has a first spring with a soft characteristic as well as at least one second spring with a harder characteristic, said first spring and said second spring being arranged one after another in the direction of the spring element and are connected with one another at a mounting point, said magnet array or said magnetic field sensor being fastened to said mounting point.

4. A device in accordance with claim 1, wherein said magnetic field sensor is fastened to said chassis and said magnet array is fastened to said spring element.

5. A device in accordance with claim 3, wherein the first spring is a coil spring and the second spring is a plate spring.

6. A device in accordance with claim 1, wherein said magnetic field sensor is a linear Hall IC.

7. A device in accordance with claim 2, wherein in the normal position of the motor vehicle, said magnetic field sensor detects the area of said air gap in which the field intensity equals zero.

8. A device in accordance with claim 2, wherein in a spring compression state said magnetic field sensor detects the area of said air gap in which the field intensity is zero in case of a maximum allowable axle load which can be set.

9 -10. (canceled)

11. A motor vehicle with level control, the motor vehicle comprising:
a number of axle components;
a level control with adjusting actuators for setting a position that is optimal for the vehicle dynamics;
a chassis;
spring elements, said adjusting actuators and said spring elements being arranged between said axle components and said chassis;
a magnet array;
a magnetic field sensor displaced in relation to said magnet array in case of a change in the spring compression position of the motor vehicle-said magnet array or said magnetic field sensor being arranged at a point of said spring element that moves during a change in the spring compression position both in relation to said chassis and in relation to said axle component.

12. A motor vehicle according to claim 11, wherein said magnet array has two like magnetic poles facing each other relative to an air gap, wherein the magnetic field intensity becomes zero in one area of said air gap wherein in a spring compression state said magnetic field sensor detects the area of said air gap in which the field intensity is zero in case of a maximum allowable axle load which can be set to provide an overload sensing.
